(19) United States
(12) Patent Application Publication
(10) Pub. No.: US 2022/0051284 A1
(43) Pub. Date: Feb. 17, 2022

(54) System and Method for Providing Selective Savings at a Retail Outlet

(71) Applicant: David Lidman, Cotuit, MA (US)

(72) Inventor: David Lidman, Cotuit, MA (US)

(21) Appl. No.: 16/990,093

(22) Filed: Aug. 11, 2020

(51) Int. Cl. G06Q 30/02; G06Q 20/40

(52) U.S. Cl. CPC G06Q 30/0234; G06Q 20/401; G06Q 30/0213

(57) ABSTRACT

A networked and computerized system is disclosed for providing savings and discounts to certain individuals at the time of purchase from a retail outlet. Specifically, savings and discounts may be provided to SNAP recipients by manufacturers when certain products are purchased. The individuals eligible for such discounts are determined based upon the payment information. Discounts can be taken at the time of purchase or may be transferred to another account.

### BACKGROUND OF THE INVENTION

### 1. Field of the Invention

The present invention relates to financial systems utilized in connection with retail distribution of products. More particularly, it relates to a system for providing selective savings or discounts based upon a status of a purchaser's payment account.

### 2. Discussion of Related Art

The Supplemental Nutrition Assistance Program (SNAP) combines federal, state and private entities in order to provide food to the poor and disadvantaged. SNAP is funded principally by the federal government. The states determine eligibility within defined federal guidelines and distribute funds to qualifying families and individuals. States may also provide additional funds. Recipients can use the funds to purchase items at ordinary retail outlets. There are limits on the types of items which can be purchased with SNAP funds. For example, SNAP funds cannot be used to purchase alcohol. The retail outlet must exclude prohibited items from the sale and require a different form of payment for those items.

SNAP was formerly known as Food Stamps because the funds were distributed as paper coupons with designated values. Recipients would use the coupons like cash to purchased allowed items. The retail outlet would then redeem the coupons with the state to collect the funds. There were many problems with the use of coupons. Coupons could be lost or stolen and required a tedious process for replacement and a loss of food for those most in need. Coupons could be counterfeited or improperly obtained. The needy were preyed upon by persons purchasing coupons at less than face value to get ready cash or for other purchases. Retail outlets had additional costs relating to the process for redeeming coupons. Also, the entire process created a stigma towards persons who used the coupons for purchases. Such persons were easily identifiable to other customers at retail outlets.

In the late 1990s, in order to address many of these problems and to reduce the administrative expenses of the program, coupons were phased out and replaced with Electronic Balance Transfer (EBT). EBT uses a card with a magnetic strip or a chip, identical to a credit or debit card, for the purchase of allowed items under SNAP. Most states also distribute cash assistance, including Temporary Assistance for Needy Families (TANF) and unemployment benefits, through the same EBT cards. The states work with banks to create and maintain accounts for recipients to receive and spend their SNAP and cash benefits. Benefits are deposited by the states into an account at a participating bank for the recipient. The recipient receives a EBT debit card for accessing the funds in the account. The debit card may be used for purchases at a retail outlet and may be used to obtain cash, at a bank, ATM or as cash back in a purchase. Funds in the account can only be used in accordance with the rules of the program providing the funds. For example, SNAP funds are limited to the purchase of food. Those funds cannot be used for other purposes or removed as cash. Other funds in the account may be able to be removed as cash.

As a public-private partnership, SNAP is able to provide benefits to needy people in an efficient manner. While retail outlets and banks are able to provide some benefits in connection with the process, it would be helpful if other companies could also provide contributions to help the needy in relation to SNAP. In particular, a need exists for product manufacturers to participate in the program and provide discounts and savings to persons in the SNAP program.

### SUMMARY OF THE INVENTION

A computerized point of sale system comprises a receiver for receiving and storing discount information from at least one manufacturer identifying products subject to discounts available to a specified group of purchasers; and a register attached to the receiver for generating a total of purchases, receiving payment information, and determining whether a purchaser is in the specified group of purchasers based upon the payment information.

A method for operating a computerized point of sale system comprises the steps of receiving at least one product discount information from at least one manufacturer, the product discount information including a product, a discount amount, and a specified group of purchasers eligible to receive the discount amount upon purchase of the product, accumulating a list of products being purchased by a purchaser and accompanying prices, generating a total of purchases, receiving payment information, and determining whether the purchaser is within the specified group of purchasers based upon the payment information.

A method for operating a computerized account system providing payments from at least one account to at least on retail outlet, the method comprises the steps of receiving at least one product discount information from at least one manufacturer, the product discount information including a product, a discount amount, and a specified group of purchasers eligible to receive the discount amount upon purchase of the product, receiving purchase information when an owner of the at least one account makes a purchase using the at least one account, and requesting and receiving a payment from a manufacturer in accordance with the discount information when the purchase information includes the purchase of a product in the discount information.

### BRIEF DESCRIPTION OF THE DRAWINGS

FIG. 1 is a block diagram illustrating a system of connected computerized components for implementing the methods of the present invention.

FIG. 2 is a block diagram illustrating the operation of a point of sale system.

FIG. 3 is a block diagram illustrating the operation of an account system.

FIG. 4 is a block diagram illustrating another operation of an account system.

FIG. 5 is a block diagram illustrating another operation of an account system.

### DETAILED DESCRIPTION

The present invention provides a system and method for providing savings or discounts to a specified group of people. In particular, the savings or discounts may be provided to a specified group of recipients, such as discount recipients (e.g., SNAP recipients) by manufacturers of purchased products. When a discount recipient purchases the designated products, the discounts may be provided automatically by the system without additional actions being required by the purchaser or the cashier.

The system includes a point of sale system operating to provide discounts to discount recipients (e.g., SNAP recipients). The identity of discount recipients may be determined automatically from the payment used by the purchaser. Payment information, either from an EBT card or from the payment network which processes the payment, may identify the purchaser as a discount recipient and may apply the discounts to the purchase. The discount may be transferred to another account rather than being applied to the purchase. The point of sale system may receive discount information from the manufacturer.

The system may include an account system connected by a network to the point of sale system. The account system may provide payments in connection with purchases at the point of sale system. The account system may receive purchase information from the point of sale system regarding products being purchased. The purchase information may include a list of items being purchased. The account system may apply manufacturer discounts to payments and/or accounts when designated products are purchased.

The account system may receive discount information from the manufacturer. The purchase information may include an amount of manufacturer discounts determined by the point of sale system.

The account system may apply manufacturer discounts to the payment account of the purchaser (e.g., an eligible purchaser). The account system may apply the manufacturer discount to a second account separate from the payment account of the purchaser.

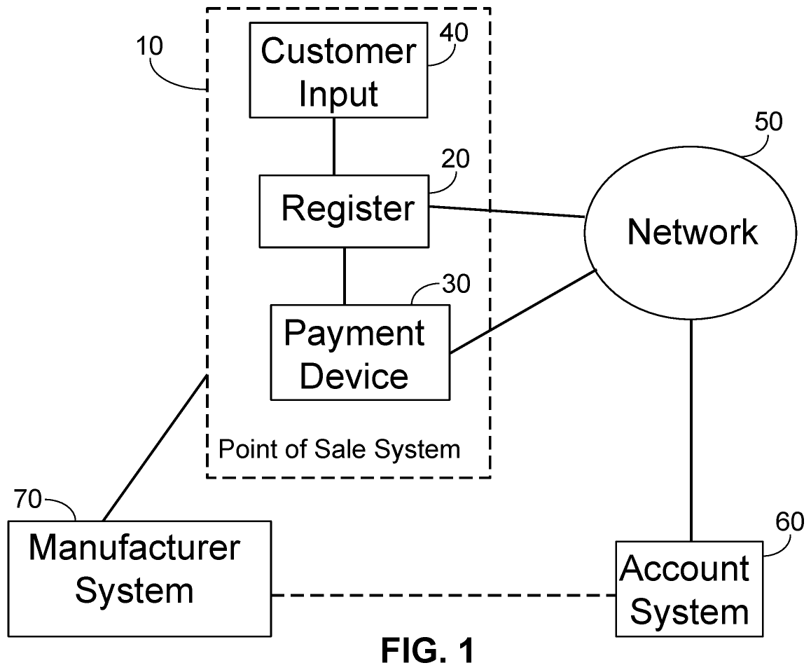

Various embodiments of the present invention are illustrated in FIGS. 1-5. FIG. 1 represents a system for implementing the invention. The physical structure and interconnections of various components are known to a person of ordinary skill in the art. Known components may be programmed in a novel way in order to perform functions as described in this disclosure but not previously known or used in connection with such components. The components and any unique functions and/or programming may be described herein.

As show in FIG. 1, a point of sale system 10 (e.g., for use at a retail outlet) may include a register 20 and a payment device 30. The point of sale system 10 may also include a customer input device 40. The point of sale system 10 may be connected through a wired or wireless network 50 to an account system 60. Either the register 20 or the payment device 30 may be connected to the network 50. A manufacturer system 70 may be connected to either the point of sale system 10 or the account system 60.

The point of sale system 10 may perform many functions as are known to a person of ordinary skill in the art. The register 20 may be operated to receive inputs for products to be purchased. These inputs may include reading barcodes, entering product numbers, or any other known method for receiving product information. The register 20 may use internal data to determine prices for the entered products. The prices may include discount or savings as provided by the retail outlet based upon the products or upon the identity of the customer. The customer may be identified either by an input on the register or using the customer input device 40. The customer may input a loyalty account number, swipe a magnetic strip on a loyalty card, or scan a bar code on a loyalty card with the customer input device 40. Many retail outlets provide discounts on products for members of their loyalty program. Discounts may be provided when the customer is properly identified (e.g., applicable discounts may be accumulated). The customer may also use manufacturer coupons to obtain discounts. The manufacturer coupons may be entered into the register and information in the internal storage may be used to determine the amount of any discounts applicable to the presented coupons.

After all discounts have been applied, a total amount due may be presented to the customer for payment. Payment may be made through the payment device 30. The payment device 30 may be incorporated into the register 20 or may be a physically separate device attached to the register 20 for communication with the register. The payment device 30 may be operated by the cashier or by the customer. The payment device 30 may be used to enter payment information for electronic payments to the retail outlet. The payment device 30 may include a magnetic strip reader, a chip card reader, or a proximity reader for obtaining account information from a card or device of the customer. The payment device 30 may include a keyboard or pin pad for entering additional information necessary to verify the identity of the customer. The payment device 30 (directly or through the register 20) may transfer account information and purchase information to a payment network 50. The payment network 50 may communicate with an account system 60 (e.g., transmitting data), such as a bank or credit institution, and may determine whether the customer information is accurate, whether the account exists, and/or whether the account has sufficient funds or credit to complete the purchase. The account system 60 may provide authorization for the purchase.

A manufacturer system 70 may provide information about discounts from a manufacturer which may be applicable to specified customers, specifically discount recipients (e.g., aid recipients). Manufacturer discounts may operate in a manner similar to manufacturer coupons. When a discount recipient purchases a designated product, a discount may be applied to the total purchase amount due. The number and amount of such discounts may be periodically processed by the retail outlet and may be provided periodically to the manufacturer. The manufacturer may pay the retail outlet for the amount of the discounts, or may provide a credit for the amount to be used on future purchases or amounts due. Manufacturer system 70 may communicate to the point of sale system 10 the products and the amounts of discounts (e.g., transmitting product discount information). Similar systems are known in connection with coupons where the manufacturer provides barcodes, products, and coupon amounts to retail outlets in order to process coupons. However, in accordance with this disclosure, neither physical nor electronic coupons are used. Instead, the discounts may be applied upon identification of a discount recipient as described below.

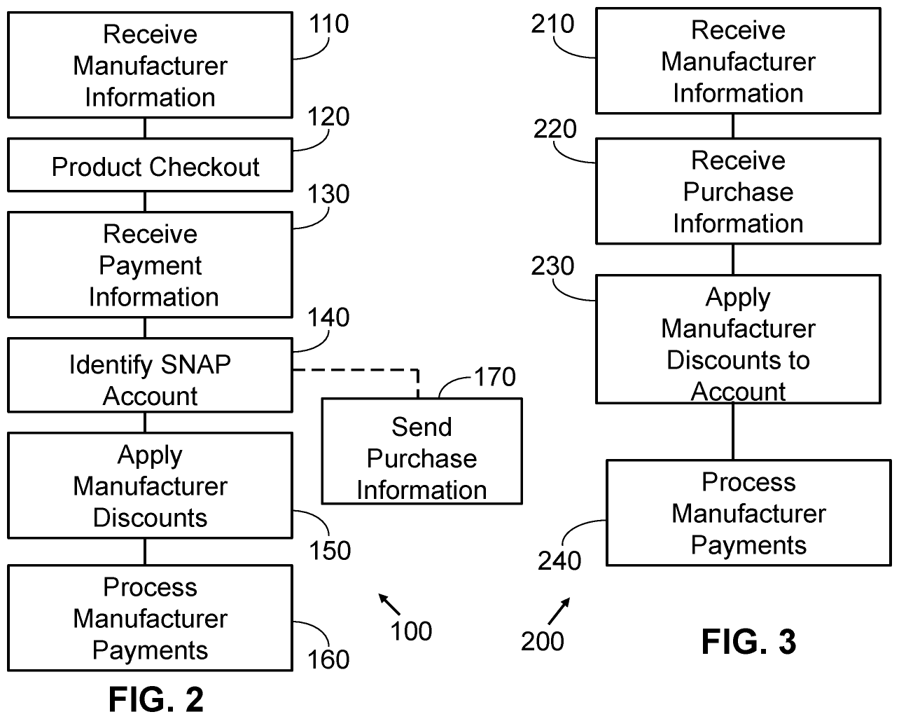

FIG. 2 is a block diagram illustrating the operation 100 of a point of sale system incorporating a register (e.g., register 20 of FIG. 1). The register 20 may perform each of the functions described herein or may communicate with other components of the point of sale system 10 to complete such functions. At step 110, the register 20 may receive discount information from the manufacturer system 70. The manufacturer system 70 may communicate discount information at such times as information is changed or updated. Discount information may include the products covered by a discount and the amount of the discount. The register 20 or point of sale system 10 may store the discount information in internal storage so that it can be retrieved when a corresponding product is purchased. The format and procedures for storing and retrieving discount information may be similar to those used for product prices and manufacturer coupons.

At step 120, the register 20 may perform a product checkout using known procedures and processes. Product information may be input into the register and the product prices and total amounts due may be determined.

At step 130, payment information may be received. As discussed above, payment information may be obtained through interaction of the register 20, payment device 30, network 50 and account system 60. Payment information, as may be received by the register 20 at step 130 may include at least account information (such as a credit card number, debit card number, electronic account, and source), an authorization code, and/or an authorized amount.

At step 140, the register 20 may identify a discount account (e.g., a SNAP account) based upon the payment information. Different mechanisms may be used to identify a discount account. First, account number information may identify a discount account. With credit cards, the first few numbers represent the type of card. VISA cards use different numbers than MasterCard, Discover and American Express. EBT cards may also use different numbers so that SNAP accounts can be identified. Second, the payment information received at step 130 may include an identification code for a discount account. The account system 60 may provide this identification code based upon the type of account associated with the account information provided to it. Third, the EBT card includes information identifying it as a discount account. The information may be incorporated into the magnetic stripe or chip used on the card. Fourth, a cashier may enter a code from the EBT card to identify a discount account. These mechanisms for identifying a discount account from the payment information are presented in no particular order. This disclosure is not limited to these mechanisms and may include any other similar mechanisms, or any other mechanisms known by a person of ordinary skill in the art useful for identifying a discount account.

If the payment information does not include a discount account, the purchase transaction is completed in a known manner.

If a discount account is identified, the register may perform additional steps as illustrated in FIG. 2. At step 150, the register 20 may apply manufacturer discounts to the transaction. The register 20 may access internal storage to retrieve discount information relating to the purchased products. Discounts may be deducted from the total amount due and the account may be charged for the reduced amount. Thus, the discount recipient may be able to receive a reduced price provided by manufacturers for designated products.

At step 160, the register 20 (or the point of sale system 10) may process the discounts to receive payments from the manufacturer corresponding to the amount of the discounts provided (e.g., such that a payment may be deposited into an account of the retail outlet). Step 160 may be performed periodically rather than with each transaction (e.g., hourly, daily, weekly, monthly, or at normal time intervals). Step 160 may be performed using mechanisms and processes similar to processing of manufacturer coupons.

Manufacturer discounts may be processed and credited by the account system 60 rather than the register 20 (or point of sale system 10), such as using purchase information for the products being purchased. Therefore, if the register 20 identifies a discount account at step 140, it may send purchase information through the network 50 to the account system 60 at step 170. Purchase information may include barcode numbers or other information identifying the product purchased. Step 170 may be an alternative to steps 150 and 160. The transaction may be completed in the usual manner with the retail outlet receiving full payment for the purchases.

FIG. 3 is a block diagram illustrating a process 200 in an account system (e.g., account system 60 of FIG. 1) for processing discounts. At step 210, the account system 60 may receive manufacturer information from the manufacturer system 70. The manufacturer information may be identical to the information which would be provided to the point of sale system 10, including product numbers and discount amounts. The manufacturer information may be stored in internal storage in the account system 60 for later retrieval.

At step 220, the account system 60 may receive purchase information from the register 20 or point of sale system 10. The purchase information may include product numbers for products purchased in the transaction. With the product numbers, the account system 60 may determine and apply manufacturer discounts to the customer account at step 230. Manufacturer discounts may be determined by accessing the stored manufacturer information relating to the product numbers. Although discount benefits (e.g., SNAP benefits) may have limitations on their use, the manufacture discounts applied to the customer account may not have the same limitations. Therefore, the customer may be able to access the manufacturer discounts as cash or purchase of products outside the relevant limitations.

At step 240, the account system 60 may process the manufacturer discounts for payment from the manufacturer. The processing of manufacturer payments may be similar to the processes used by the register 20 or point of sale system 10 in obtaining payments.

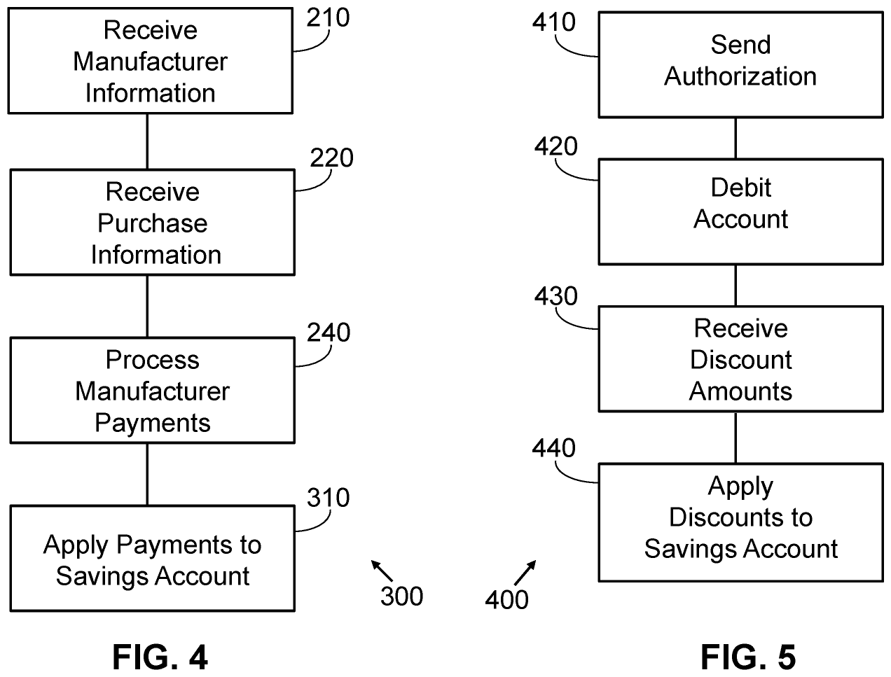

FIG. 4 is a block diagram illustrating a process 300 in an account system (e.g., account system 60). Here, the manufacturer discounts may not be applied to the same customer account from which the payment is made. Instead, the manufacturer discounts may be applied to a separate savings account. The process 300 in the account system 60 may be similar to process 200, as set forth with respect to FIG. 3. As with respect to process 200, the process 300 may receive manufacturer information (step 210) and purchase information (step 220). These steps may function identically to the steps discussed above with respect to FIG. 3. Similarly, the account system 60 may process manufacturer payments at step 240. At step 310, the manufacturer payments from a transaction may be applied to a savings account. The savings account may be owned by and accessible to the purchaser, or may be owned by another person or entity designated by the purchaser. In this manner, the savings may be donated to another person or a charitable organization.

FIG. 5 is a block diagram illustrating a process 400 in an account system (e.g., account system 60) for processing discounts. Here, the retail outlet may determine discounts and process manufacturer payments in the same manner as set forth in operation 100, as illustrated in FIG. 2. When a discount account is identified, the register 20 may send purchase information to the account system 60 (step 170 in FIG. 2) and further may apply the discounts to the purchase transaction. The purchase information may include discount amounts determined by the register 20. As set forth in FIG. 5, the account system 60 may send an authorization for a purchase transaction in step 410. The authorization may be for the amount of the purchase transaction less any discount amounts. At step 420, the account may be debited for the full amount of the purchase transaction. At step 430, the account system 60 may receive the discount amounts as part of the purchase information from the register 20. At step 440, the account system 60 may apply the discount amounts to a savings account. The savings account may be associated with the purchaser or another entity designated by the purchaser.

The present invention may have been described above with respect to recipients of discounts (e.g., SNAP recipients). The system of the present invention is particularly useful for such persons in order to provide additional benefits from manufacturers who are willing to help those in need. However, the present invention is not limited to SNAP recipients nor to manufacture discounts. Other types of customers can be accommodated in the system when the payment information or authorization information is used to identify accounts to which discounts may be applied. Discounts may also be provided by the retail outlet or other entities based upon the status of the customer.

Having described several embodiments of the invention, various extensions and alternatives may be readily apparent to those of skill in the art. Such extensions and alternatives are considered to be part of the invention, which is only limited by the several claims attached hereto.

1. A discount system comprising:
at least one manufacturer system providing discount information for products;
a point of sale register generating a total of purchases; and
a receiver located within the point of sale register, the receiver receiving and storing the discount information from the at least one manufacturer system;
wherein the point of sale register identifies products subject to discounts based on the discount information, receives purchaser information, determines eligibility of a purchaser to receive discounts based upon the purchaser information, and applies the discounts to the total of purchases based on the eligibility of the purchaser, wherein the point of sale register communicates the discounts to the at least one manufacturer system, and wherein the at least one manufacturer system applies a credit to an account of a retail outlet in the amount of the discounts.

2. The discount system according to claim 1, wherein the point of sale register further deducts discount amounts based upon the discount information of products purchased.

3. The discount system according to claim 1, wherein the point of sale register further transmits the discount information to an account system.

4. The discount system according to claim 1, wherein the purchaser information includes an account number and at least a portion of the account number identifies a specified group of purchasers.

5. The discount system according to claim 1, wherein the point of sale register further transmits a list of purchased products to an account system associated with the purchaser based on the purchaser information.

6. A method for operating a discount system that provides payments from an account of a purchaser to a retail outlet, the method comprising the steps of:
providing discount information for products from at least one manufacturer system, the discount information including any number of a product, a discount amount, and a specified group of purchasers eligible to receive the discount amount upon purchase of the product;
accumulating on a register purchase information formed of a list of products being purchased by the purchaser and accompanying prices;
receiving and storing the discount information from the at least one manufacturer system on a receiver in the register;
identifying products subject to one or more discounts based on the discount information;
receiving payment information with a payment device connected to the register;
determining whether the purchaser is within the specified group of purchasers based upon the payment information;
applying the discounts to the list of products based on eligibility of the purchaser;
communicating the one or more discounts to the at least one manufacturer system; and
applying a credit from the at least one manufacturer system to an account of the retail outlet in the amount of the one or more discounts.

7. The method of claim 6 further comprising the step of applying the one or more discounts to the purchase information when the purchaser is within the specified group of purchasers.

8. The method of claim 6 further comprising the step of transmitting the discount information to an account system.

9. The method of claim 6 further comprising the step of transmitting one or more of the purchase information and the payment information to an account system.

10. The method of claim 6 wherein the payment information includes an account number and at least a portion of the account number identifies the specified group of purchasers.

11. A method for operating a discount system in a retail outlet, the method comprising the steps of:
providing discount information for products from at least one manufacturer system, the discount information including any number of a product, a discount amount, and a specified group of purchasers eligible to receive the discount amount upon purchase of the product;
receiving on a register purchase information of products to be purchased by a purchaser;
receiving and storing the discount information from the at least one manufacturer system on a receiver in the register;
identifying products subject to one or more discounts based on the discount information;
receiving account information with a customer input device connected to the register;
determining whether the purchaser is within the specified group of purchasers based upon the account information;
applying the discount information to the purchase information of products based on eligibility of the purchaser; and
communicating the one or more discounts to the at least one manufacturer system, and the at least one manufacturer system applying a credit to an account of the retail outlet in the amount of the one or more discounts.

12. The method of claim 11, wherein the credit is a cash payment.

13. The method of claim 11, wherein the credit is a credit on future purchases.

14. The discount system according to claim 1, wherein the point of sale register includes a payment device receiving the purchaser information in the form of payment information.

15. The discount system according to claim 1, wherein the point of sale register includes a customer input device receiving the purchaser information in the form of account information.

16. The method of claim 9, wherein the account system performs at least one or more of identifying the account of the purchaser in the account system based on the payment information, authorizing the purchase, and providing payment for the purchase.

17. The method of claim 7, further comprising the step of transmitting one or more of the purchase information and the payment information to an account system.

18. The method of claim 17, wherein the account system identifies the account of the purchaser based on the payment information and provides payment for the purchase from the account of the purchaser.

19. The method of claim 18, wherein the payment provided by the account system is based on the purchase information with the one or more discounts applied.

20. The method of claim 18, wherein the payment provided by the account system is based on the purchase information without the one or more discounts applied, and the account system provides a second payment to a second account designated by the purchaser in the amount of the one or more discounts.
